(19) United States
(12) Patent Application Publication
(10) Pub. No.: US 2002/0038478 A1
(43) Pub. Date: Apr. 4, 2002

(54) Process for manufacturing leather

(76) Inventor: Paul Edward Crossley, Leeds (GB)

Correspondence Address: KENYON & KENYON, ONE BROADWAY, NEW YORK, NY, 10004, US

(21) Appl. No.: 09/906,591

(22) Filed: Jul. 16, 2001

(30) Foreign Application Priority Data
Jul. 14, 2000 (GB) 0017212.2

(51) Int. Cl. D06N 7/04; C14C 1/00

(52) U.S. Cl. 8/94.15; 428/151; 428/904; 8/94.19 R

(57) ABSTRACT

A novel pre-tannage system for leather comprises treating the pelt or hide with a zeolite material in a first pre-tannage step and thereafter treating the pelt or hide with one or more modified aldehyde tanning agents. In this condition the pelt or hide is suitable for a number of different tanning steps namely chrome tannage, vegetable tannage, synthetic tannage or a combination of these.

The present invention relates to an improved process for manufacturing leather, in particular heavier leathers. It also relates to leather products produced by the improved process.

In order to turn animal skins into leather they are subjected to a series of process steps known as tanning.

The purpose of tanning is to bring about the irreversible stabilisation of skin that is otherwise prone to putrefaction. The object of converting the skin into leather by tanning it is to stabilise it against enzymatic degradation and to impart desirable properties. Tanning raises its shrinking temperature, increases its resistance to hot water as well as reducing its shrinkage in volume, area or thickness and reducing its deformability. These effects are achieved by cross-linking the collagen chains with various tanning agents.

In typical leather manufacture, before entering the tanning process the raw skins are first “cured” by salting, chilling or treating them with a brine solution promptly after removing them from the slaughtered animal and before transporting them to a leather treatment factory.

Upon arrival at the factory the cured skins are soaked in pure water to remove salt, blood, dung and other dirt. Soaking also serves to rehydrate the skins in preparation for fleshing. The soaked skin is passed through a fleshing machine which mechanically removes flesh or fat deposits from the flesh side of the soaked skin thereby facilitating chemical penetration in subsequent process steps.

A word may be said here about terminology. The initial material is referred to herein as a skin, by which term we include hides. After soaking, but before tanning, a skin is usually referred to a pelt. However, unless the context indicates otherwise the term “skin” as used herein does not preclude a soaking step or other steps having been carried out.

In order to remove hair, epidermis and residual inter fibrillary components from the pelt it is soaked for a period of 14 to 24 hours in a solution containing e.g. lime and sodium sulphide. This step of liming also serves to open up the fibre structure of the pelt.

Following “liming” the skins (or pelts) are subjected to deliming by soaking them in a weak acid solution using, for example, ammonium sulphate and ammonium chloride which reacts with the mechanically or chemically bound lime to form water soluble salts which can be washed from the skin, thus removing the lime. Most types of skin are simultaneously treated with a “bating” material consisting of enzymes—usually pancreatic, which are used to remove residual components broken down in the lime. The bating material has the additional benefit of giving a smoother grain and rendering the skin soft and flexible.

After the deliming and bating steps the skins are washed in water several times to prepare them for pickling. The purpose of the pickling stage is to acidify the skins to a certain pH prior to tannage. Tannage can be effected using metal salts, usually chromium salts, but aluminium or zirconium salts or mixtures thereof may be used. Alternatively the skins can be tanned using vegetable tanning materials.

When using metal salts to tan the skins, depending on the degree of tannage, the skins can either by fully tanned or part-tanned (also described as pre-tanned). After pre-tanning, but before the main tanning step, the material is frequently referred to as a pre-tanned substrate rather than a skin or pelt. However, unless the context indicates otherwise the term “skin”, as used herein does not preclude some pre-tanning having been carried out. Whilst metal salts have been used as pre-tanning agents, their use is generally confined to specialist leathers. Pre-tanning of skins subsequent to the pickling stage is more commonly carried out using modified aldehydes, such as glutaraldehyde and modified glutaraldehyde.

Such pre-tannage techniques are most commonly in use in the production of automotive upholstery leathers. Automotive leathers are usually at the lighter end of the substance (thickness) range, and thus obtaining the desired aesthetic requirements is technically possible with the correct use of other auxiliary chemicals. When producing leather for shoe upper and/or leathergood type products the required substance is generally heavier, and the “tightness” of grain feature is of a more critical nature.

Following pre-tannage the treated skin has sufficient thermal and dimensional stability that it can be mechanically treated to split or shave it. Having been split or shaved, the skin is processed further using chromium or other minerals, vegetable extracts, synthetic tanning agents or a combination thereof.

In order to produce heavier leathers suitable for the production of shoe upper and/or leather for leathergoods—complete tannage using chrome tanning or vegetable tanning has conventionally been used. If however a pre-tannage route is adopted, it may also be necessary to use other synthetic tanning agents in any pre-tannage system that may have been used in order to impart the increased tannage effect required to produce heavier leathers. The use of other synthetic tanning agents over and above the quantities usually required when making leather in a conventional way adds a high chemical cost to a conventional pre-tannage system; for example from 4 to 8% of additional tanning agent is added to a conventional pre-tannage system. Such tanning agents are relatively expensive and this, combined with the percentage offer required, adds substantial cost to the product.

The use of sodium aluminium silicate as a tanning agent is known (see for example Nicola Constantini and Francesca Ciardetti (University of Pisa (Italy)) and A. D. Covington BLC, Northampton UK [JALCA, Vol 95(4), 2000]). Sodium aluminium silicate dissolves in acid liquor, pH <5, because of hydrolysis to alkaline aluminium salts and low molecular weight polysilicic acids, whereby acid is consumed. These hydrolysis products have a tanning effect on skins. Sodium aluminium silicate is, however, insoluble in the neutral and alkaline zone.

Although sodium aluminium silicate has been used for tanning leather in the past, it has always been added in the acidic phase with the result that it hydrolyses to alkaline aluminium salts and polysilicic acids straight away. As the sodium aluminium silicate has not fully penetrated the skin prior to it becoming an active tanning agent, the tanning action can be predominantly restricted to the outer layers of the skin.

There is a considerable commercial demand for an economic pre-tannage process which produces a skin (or pre-tanned substrate) which can be re-tanned in a variety of different ways, e.g. vegetable tanning, chrome tanning and syntan. However existing pre-tannage processes still produce a leather which, after splitting and shaving, has a loose texture that is aesthetically unacceptable for the finer quality leathers that command substantial price premiums. Also the loose texture means that for many applications excessive trimming is needed which results in a loss of area yield. In an attempt to overcome this problem we tried numerous different compositions and processes that were unsuccessful.

It has now been found unexpectedly and contrary to previous teaching, that by adding a zeolite such as sodium aluminium silicate, and drumming it into the skin in a process vessel, preferably at a pH of from 8-13, and preferably following deliming, bating and washing of the skins and prior to pickling and pre-tanning, the zeolite is deposited within the fibre structure of the skin. Subsequent addition of acid during the pickling hydrolyses the zeolite in situ.

This addition imparts an increased tannage effect to the pre-tannage system using, for example, modified aldehydes, resulting in a substrate suitable for the production of shoes or other footwear or gloves or articles of clothing or leather for leather goods such as bags, saddlery and belts. Other relevant leather goods include watch straps, wallets, household goods, internal decoration or ornaments such as vases and bowls as well as sculptures, wall and floor coverings, bins and other containers and industrial goods such as seals and bellows, and furniture (both upholstery and structural). The leather is particularly suitable for shoe upper and chrome-free leather. The leather may also be used to produce balls, particularly baseballs. Any of these products may be made wholly or partially from the leather in question. The invention allows white or cream coloured leather to be made particularly efficiently. This is useful in the case of baseballs or other balls that usefully have a leather cover.

According to one aspect of the invention there is provided a method of producing leather which includes a pre-tannage stage in which a skin is treated with a zeolite material and thereafter treated with one or more tanning agents which may comprise for example aldehydes, modified aldehydes, chromium, aluminium or other mineral tanning agents, vegetable tanning agents, syntans or materials such as THPS (tetrakishydroxymethyl phosphonium sulphate) for example that marketed under the trademark ALBRITE CS4. The invention can result in the leather having improved dimensional stability particularly stability to heat.

The term modified aldehydes is used to describe formaldehyde, glutaraldehydes, or aldehyde compounds containing two or more aldehyde groups, and compositions or mixtures containing one or more of the aforesaid.

According to another aspect of the invention there is provided an improved process for producing leather comprising the steps of:

(a) soaking a cured skin;

(b) liming the skin;

(c) deliming the skin;

(d) pickling the skin;

(e) tanning the pickled skin with modified aldehydes;

(f) splitting or shaving the pretanned skin;

(g) retanning the split skin;

wherein the process comprises the additional step of treating the skin with a zeolite after the deliming in step (c) and before pickling the skin in step (d).

In another aspect, the invention provides a method of tanning a skin characterised by treating the skin with a zeolite before tanning the skin with, for example, a modified aldehyde.

The term zeolite as used herein means any of a group of alumino-silicates of sodium, potassium, calcium or barium containing very loosely held water which can be removed by heating and regained by exposure to a moist atmosphere without destroying the crystal structure. The preferred zeolite is sodium aluminium silicate of type zeolite ‘A’.

In one preferred method the zeolite is added to the process vessel at a rate of from 0.75% to 5.0% of skin weight, preferably 1.0% to 2.0%, most preferably 1.25% to 1.75% of skin weight in a float of 5.0% to 50.0% water, preferably about 20.0% water, at a temperature of from 10° C. to 36° C., preferably about 19° C., and at a pH of from 8 to 13.

The process vessel is then rotated at a fast mixing speed, e.g. at about 7 rpm using a vessel 4 m by 4 m, for approximately an hour. After this time the skins are pickled using a combination of formic acid, sulphuric acid and sodium formate in such a ratio to provide a final liquor or pH of 2.8-3.1. The change in pH from 8.0-13.0 to <5.0 hydrolyses the sodium aluminium silicate and tannage takes place.

One advantage of using a zeolite such as sodium aluminium silicate prior to the pretanning using modified aldehydes is that it results in a greater tannage effect i.e. improved characteristics such as enhanced resistance to shrinkage and deformability. The end product of the process is a substrate suitable for the production of shoe and leathergoods leather, which is obtained without the need to use large amounts of other synthetic tanning agents in the pretannage and subsequent (retannage) process steps. Thus, there is improved chemical utilisation and increased commercial viability.

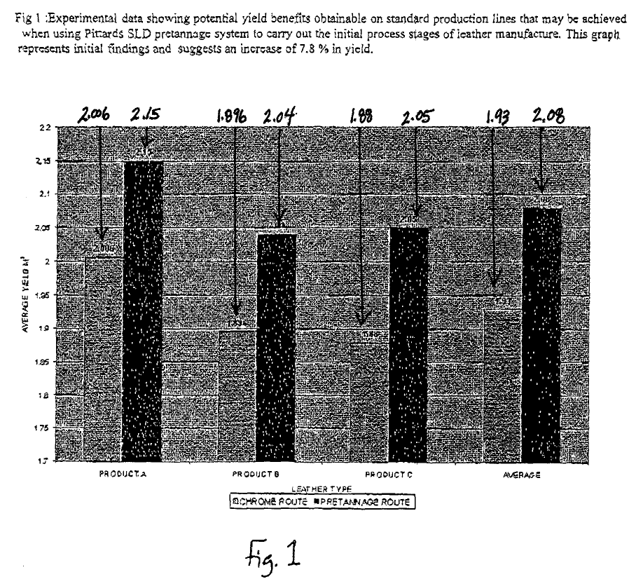

Another advantage is an improved yield of the end product because the raw material can be converted to final output footage of finished leather at a higher rate than normal when using a standard chrome tanning system. FIG. 1 of the accompanying drawings shows the increase in yield using the “pretannage” process according to the present invention compared to using the standard chrome tanning process, for three different products, and the average thereof. A further advantage is the cost difference compared to a conventional pre-tanning system. Compared to a conventional system using synthetic tanning agents, the cost of using, say 1.5% sodium aluminium silicate and 1% synthetic tanning agent will add £0.017 per square foot (£0.18 per square meter) as compared to £0.033-£0.067 per square foot (£0.36-£0.72 per square meter), when using 4-8% synthetic tanning agent.

Yet another advantage is the improved chemical penetration leading to improved performance characteristics of the end product.

The invention will be further described with reference to the following example.

### EXAMPLE

Soaking

The skins to be treated were added to a conventional drum into which was introduced an offer of 100% water and 0.1% wetting agent at 21° C. The drum was run at a slow speed (3 rpm) for a period of one hour. The drum was then drained for 30 minutes after which an offer of 0.01% bactericide, 0.3% sodium carbonate and 0.1% wetting agent and 100% water at 21° C. was added and the drum then run for a period of two hours at a slow rate (3 rpm). The drum was then emptied.

Fleshing

The skins (or pelts) were then removed from the drum and fleshed using a fleshing machine to remove flesh or fat deposits from the flesh side of the skin. The skins were then returned to the drum.

Liming

In this and the following steps, the term “offer” and quoted percentages of material are by reference to the weight of the skins at the start of the Liming Process. A mixture of 0.1% sodium carbonate and 100% water was added at 25° C. and the drum run for two and a half hours at a slow speed. Thereafter a mixture of 2% lime and 0.75% sodium hydrosulphide were added and the drum driven at slow speed for 20 minutes and then allowed to stand for 20 minutes. Thereafter 0.4% liming auxiliary compound (amine salt mixture), together with 1% lime and 2% sodium sulphide, was added. The drum was then run at a slow speed for 20 minutes and allowed to stand for 40 minutes. Thereafter 0.2% of a slipping agent was added to the drum which was then run at a slow speed for 20 minutes followed by a further stand period of 40 minutes. The drum was then run intermittently (three minutes every hour) for a period of fourteen hours, at a slow speed.

Washing

A 100% offer of water was then added to the drum at a temperature of 31° C. and the drum run at a slow speed for ten minutes and then drained for 30 minutes. Another 100% offer of water at 31° C. was added and the drum run this time for 15 minutes and then allowed to drain for 30 minutes. A further offer of 100% water at 35° C. was added to the drum which was then run at a slow speed for 15 minutes and the drum then drained for 30 minutes.

Deliming

100% water at 35° C. and 0.25% ammonium sulphate were added to the drum and the drum run at a slow speed for 15 minutes. The drum was then allowed to drain for 30 minutes. An offer of 100% water and 0.25% ammonium sulphate at 35° C. was added and the drum was run for 20 minutes at a slow speed and then allowed to drain. Thereafter a mixture of 30% water, 1% ammonium sulphate, 1% ammonium chloride, 1% delime auxiliary (ammonium salt compound of inorganic and aromatic acids), 0.2% sodium metabisulphite and 0.1% wetting agent was added and the drum run at a slow speed for 40 minutes. The pH at this stage should lie in the range of from 8.8 to 9.2. Thereafter 0.3% formic acid diluted 1:10 w/w with water at 19° C. was added and the drum run for 30 minutes at a slow speed. An offer of 70% water at 35° C. was added together with 0.03% pancreatic enzyme and the drum run at a fast speed (7 rpm) for 40 minutes. At this stage the skin may be tested for delime penetration using phenolphthalein indicator and the pH should lie in the range of 8.7 to 9.1.

Washing

The drum was drained for 10 minutes and 120% water is added at a temperature of 20° C. The drum was run at a slow speed for 15 minutes and allowed to drain for 10 minutes. A further offer of 120% water at 20° C. is added to the drum and the drum run for 15 minutes at a slow speed.

Sodium aluminium silicate treatment

An offer of 8% water and 1.5% sodium aluminium silicate (type zeolite A) was added and the drum run at a fast speed (7 rpm) for a period of one hour.

Pickling

An offer of 5% sodium chloride, 1% sodium formate and 0.08% sodium metabisulphite is added and the drum is run at a fast speed for 30 minutes. Thereafter 1% formic acid (85%) diluted 1:10 with water at 19° C. was added and the drum run at a fast speed for 30 minutes. 1.6% sulphuric acid (98%) diluted 1:10 with water at 19° C. was then added and the drum run for two hours at a fast speed. At this stage the pH should lie in the range of 2.9 to 3.1 and the temperature in the range of 23° C. to 27° C. At this stage the pickle penetration may be tested by means of bromocresol green indicator, and this should indicate at least 60% penetration of pickle i.e. 60% yellow to bromocresol green indicator.

Tannage

2% modified gluteraldehyde was added and the drum was run for 5 hours. 1% sodium bicarbonate was then added and the drum run for 60 minutes. The pH at this stage should lie in the range of 3.8 to 4. An offer of 100% water and 1% syntan at 35° C. was added and the drum run for 60 minutes.

At this stage the skins (or pre-tanned substates) may be washed off and subjected to further processing. Thus the skins may be subjected to a samm/sett process followed by sorting and splitting or shaving. Thereafter the skins may be subjected to one or more of chrome tannage (to provide for example upper leather or suede), vegetable tannage, synthetic tannage or a combination tannage.

1. A method of producing leather which includes a pre-tannage in which a skin is treated with a zeolite material and thereafter treated with one or more tanning agents.

2. A method according to claim 1, wherein said zeolite is selected from the group of alumino-silicates of sodium, potassium, calcium and barium.

3. A method according to claim 1 or claim 2, wherein said zeolite is employed at an offer of 0.75% to 5% of the skin weight.

4. A method according to any of the preceding claims wherein said zeolite is added in an offer of water, the amount of water being 5.0% to 50% of the skin weight.

5. A method according to any of the preceding claims, wherein the skin is treated in a liquid at a temperature of from 10° C. to 36° C.

6. A method according to any of the preceding claims, wherein the skin is treated in a liquid at a pH from 8 to 13.

7. A method according to any of the preceding claims wherein said zeolite comprises sodium aluminium silicate.

8. A method according to any of the preceding claims, wherein the skin is agitated in a vessel in order mechanically to deposit the zeolite within fibres of the skin substantially throughout the thickness thereof.

9. A method according to any preceding claim, in which a tanning agent used in the pretannage comprises a modified aldehyde.

10. A method according to any of the preceding claims, wherein following said pre-tannage stage, said skin is subjected to a re-tanning stage.

11. A method according to claim 10, wherein said re-tannage stage comprises a chrome tanning stage.

12. A method according to claim 10, wherein said re-tannage stage includes a vegetable tannage stage.

13. A method according to claim 10, wherein said re-tannage stage includes tanning using a synthetic tanning (syntan) agent.

14. A method according to claim 10, wherein said re-tannage stage includes two or more of the following:
chrome tanning;
vegetable tanning; and
tanning with a syntan agent.

15. A process for producing leather comprising the steps of:
(a) soaking a cured skin;
(b) liming the skin;
(c) deliming the skin;
(d) pickling the skin;
(e) tanning the pickled skin with modified aldehydes;
(f) splitting or shaving the pre-tanned skin;
(g) re-tanning the split skin;
characterised in that the process comprises the additional step of treating the skin with a zeolite after the deliming in step (c) and before pickling the skin in step (d).

16. A method of tanning a skin characterised by treating the skin with a zeolite before tanning the skin with a pretanning agent.

17. A method according to claim 16, in which the pretanning agent comprises a modified aldehyde.

18. Leather produced in accordance with the method of any of claims 1 to 17.

19. A glove made wholly or partially from leather according to claim 18.

20. An article of footwear made wholly or partially from leather according to claim 18.

21. An article of clothing made wholly or partially from leather according to claim 18.

22. An article of furniture upholstered wholly or partially from leather according to claim 18.

23. Leathergoods made wholly or partially from leather according to claim 18.

24. A ball made wholly or partially from leather according to claim 18.

25. A ball according to claim 24, being a baseball.
